(19) United States
(12) Patent Application Publication
(10) Pub. No.: US 2006/0081520 A1
(43) Pub. Date: Apr. 20, 2006

(54) Pump and strainer for a pool cover

(76) Inventors: Richard B. Lord, Beverly, MA (US); Scott K. Batchelder, Newbury, MA (US)

Correspondence Address: DICKSTEIN SHAPIRO MORIN & OSHINSKY LLP, 2101 L Street, NW, Washington, DC, 20037, US

(21) Appl. No.: 10/965,224

(22) Filed: Oct. 15, 2004

(51) Int. Cl. B01D 35/26; B01D 35/027

(52) U.S. Cl. 210/169; 210/416.2

(57) ABSTRACT

A pool cover pump strainer is disclosed comprising an upper surface, a bottom surface having a strainer chamber array, and a central induction chamber. A compatible pump is secured in the central induction chamber. Water flows into the lower strainer chamber array either between the outer edge of the strainer and the pool cover, or through apertures provided in the upper surface. As water flows through the lower strainer chamber array toward the central induction chamber, debris is filtered, and water is pumped into and through the pump and away from the pool cover through an attached hose.

### BACKGROUND

During periods of disuse, swimming pools are frequently susceptible to fouling from debris such as leaves and twigs. Perhaps more importantly, swimming pools may be a hazardous attraction to various creatures such as squirrels, dogs and small children, who may enter, intentionally or otherwise, an unmonitored pool, to the detriment of the entrant and the pool. For these reasons, many swimming pool owners install flexible, anchored, tarpaulin pool covers on their swimming pools. Installing such a pool cover generally serves as a physical barrier to a swimming pool and may serve as a visual deterrent from attempting to access a pool. At the same time, however, pool covers themselves collect rainwater and debris, frequently at a low point central to the perimeter of the swimming pool. An accumulation of water may present an unacceptable load to the cover, which may stretch or break. At the very least, this accumulation complicates the eventual removal of the cover.

In order to remove accumulated water from a pool cover, swimming pool owners may place an electric pump attached to a simple strainer on the areas of the pool cover where water and debris are likely to accumulate. Known pool cover pumps may function well initially, straining water through the accumulated debris and pumping the water away from the pool cover through an outlet hose. However, as more water is strained and pumped away from the pool cover, debris accumulates at the strainer. If too much debris accumulates, the water will not be effectively strained and pumped, and the swimming pool owner must manually remove the accumulated debris in order to restore effective water straining and pumping. Repeated manual removal of accumulated debris is inconvenient and unpleasant for swimming pool owners.

Another shortcoming present in conventional pool cover pumps is that the pumps are frequently mounted on a flat base, such as a flat plastic plate, with the flat base being the part of the pump that comes in contact with a pool cover. The contact between such a flat base, and particularly the edges of the flat base, and a pool cover can result in an undesirable interface which can lead to tipping of the pump, or damage to the pool cover from the edges of the flat base.

What is needed is a pool cover pump strainer that provides longer lasting straining of accumulated debris from accumulated water to be pumped, thereby reducing or eliminating manual removal accumulated debris. What is also needed is a pool cover strainer providing a reduced risk of tipping of the pump or damage to the pool cover.

### SUMMARY

The present invention provides a pump and strainer for a pool cover with greater effective straining duration, thereby reducing the need for regular manual removal of accumulated debris. The present invention also provides a pump and strainer for a pool cover that is less likely to tip and less likely to snag or tear a pool cover than conventional strainers.

In one aspect of the invention, a pump strainer for use on a pool cover is provided having a bottom surface, the bottom surface defining a curved profile over at least a portion of the bottom surface. In another aspect of the invention, a pump strainer for use on a pool cover is provided, having a bottom surface, the bottom surface having a plurality of strainer chambers. In yet another aspect of the invention, a pump strainer for use on a pool cover is provided comprising a bottom surface, the bottom surface having at least one circular partition. Another aspect of the invention provides a pump strainer for use on a pool cover comprising a bottom surface having a generally curved profile, the bottom surface having a plurality of radial partitions and a plurality of circular partitions defining a plurality of chambers. And, another aspect of the invention provides a pump strainer comprising a top surface and a bottom surface, wherein the bottom surface is substantially open to intake a fluid into the pump strainer.

The pool cover pump strainer of the present invention is formed from molded plastic and includes an upper strainer face, a lower strainer chamber array, and a central induction chamber. Water enters the lower strainer chamber array through apertures in the upper strainer face and beneath the outside edge of the upper strainer face.

The lower strainer chamber array includes multiple strainer chambers. These strainer chambers are defined by multiple circular and radial partitions, which may be adjacent to the upper cover strainer. Water flows through successive strainer chambers and into a central induction chamber via multiple induction openings. The central induction chamber is defined by a bottom, which rests on the pool cover, and a sidewall, which includes a seat for supporting a pump. The central induction chamber also includes latches for securing the pump, as well as a screen positioner for positioning a screen outside the pump inlet as a final debris filter. The water is drawn into the pump inlet from the induction chamber, through the pump and away from the pool cover through a connected hose.

These and other features and advantages of the invention will be more clearly understood from the following detailed description and drawings of preferred embodiments of the present invention.

### BRIEF DESCRIPTION OF THE DRAWINGS

FIG. 1 is a perspective view of a pump and strainer for a pool cover in accordance with a preferred embodiment of the present invention, shown in use.

FIG. 2 is a cross-sectional elevation view of the pump and strainer of FIG. 1.

FIG. 3 is a first perspective top view of the strainer of FIG. 1 shown without the pump.

FIG. 4 is a first perspective bottom view of the strainer of FIG. 3.

FIG. 5 is a view of the strainer of FIG. 3 taken along section line V-V of FIG. 7.

FIG. 6 is a perspective view of the pump and strainer of FIG. 1.

FIG. 7 is a top view of the strainer of FIG. 3.

FIG. 8 is a second perspective top view of the strainer of FIG. 3.

FIG. 9 is a bottom view of the strainer of FIG. 3.

FIG. 10 is a second perspective bottom view of the strainer of FIG. 3.

FIG. 11 is a front-side view of the strainer of FIG. 3.

FIG. 12 is a rear-side view of the strainer of FIG. 3.

FIG. 13 is a left side view of the strainer of FIG. 3.

FIG. 14 is a right side view of the strainer of FIG. 3.

### DETAILED DESCRIPTION OF A PREFERRED EMBODIMENT

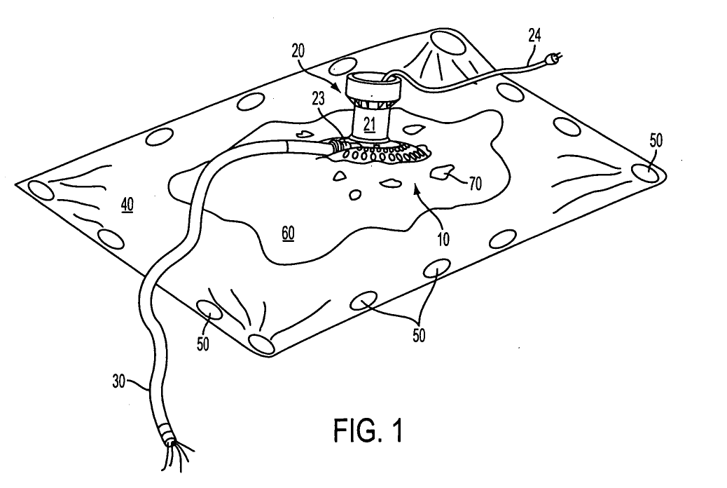

Refer now to FIG. 1, there being shown a pool cover pump strainer, generally designated by reference numeral 10, in accordance with a preferred embodiment of the present invention. Pump strainer 10 is attached to a compatible pump 20 having a pump body 21 and a power cord 24. Pump 20 is connected to an outlet hose 30 through a pump outlet 23. In use, the pump strainer 10 is positioned on pool cover 40 having an accumulation of water 60 and debris 70. The pool cover can be secured in place by weights 50. According to the present invention, water 60 enters pump strainer 10, is pumped through pump 20, and is removed from pool cover 40 through hose 30.

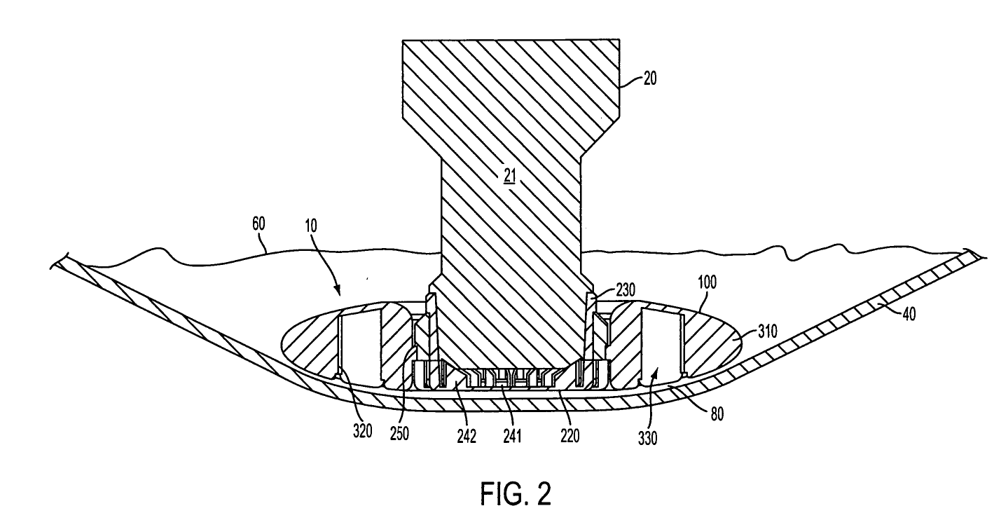

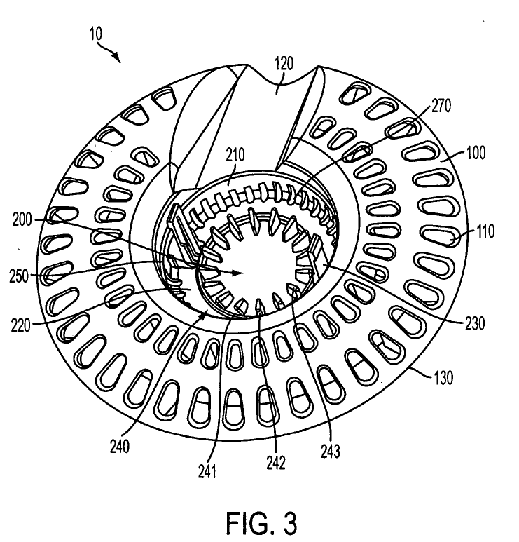

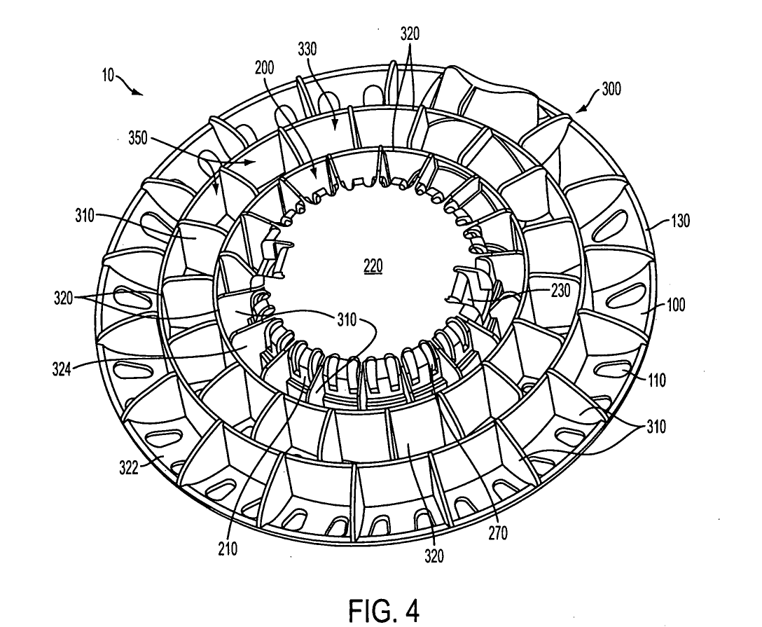

Referring now to FIG. 2, a cross section of pump strainer 10 is depicted attached to compatible pump 20 and resting on pool cover 40 and submerged in accumulated water 60. FIG. 3 depicts a perspective top view of pump strainer 10, and FIG. 4 depicts a perspective bottom view of pump strainer 10, both standing alone without pump 20, pool cover 40, or water 60.

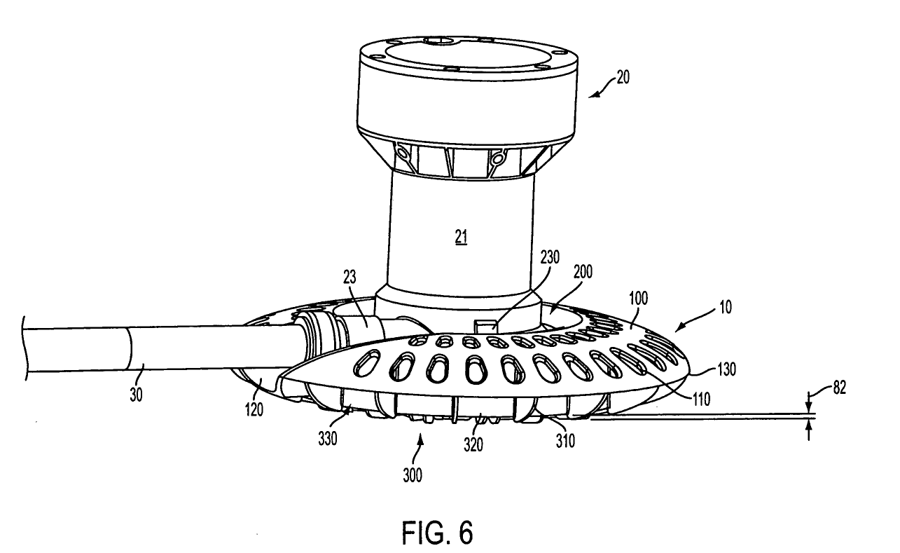

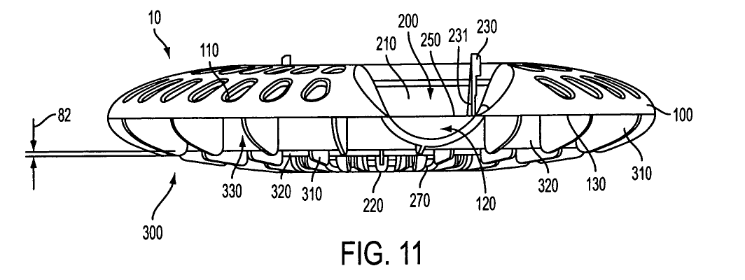

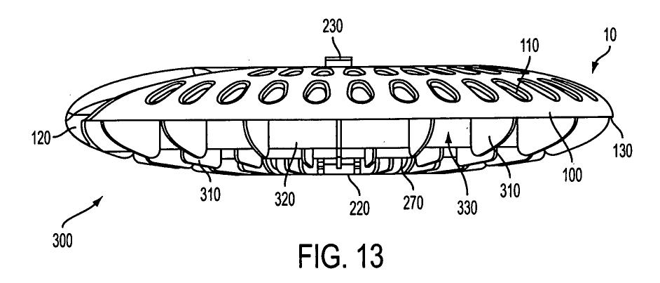

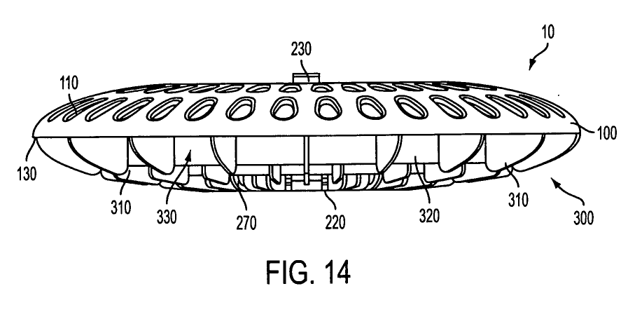

Referring to FIG. 2-FIG. 4, pump strainer 10 includes an upper strainer face 100, having apertures 110 for straining debris from water to be pumped, and an outer edge 130. The apertures 110 may be formed in a plurality of sizes and shapes to achieve a desired water flow rate and filtering function. The upper strainer face 100 is preferably generally convex, with the curved surface naturally shedding and filtering debris 70, while allowing water 60 to flow through the apertures 110. Pump strainer 10 also includes a bottom, preferably open, and more preferably including a lower strainer chamber array 300 adjacent and beneath the upper strainer face 100. Water flows from the upper strainer face 100, through the apertures 110, to the lower strainer chamber array 300. Water also flows into the lower strainer chamber array 300 through a space between outer edge 130 of the pump strainer 10 and the pool cover 40. (See also FIG. 6 and FIG. 11-14).

Lower strainer chamber array 300 preferably includes circular partitions 320, which in a preferred embodiment are concentric to the shape of outer edge 130. The circular partitions 320 together form multiple circular openings, which may be concentric circular openings, as shown in FIG. 4. The outermost circular opening 322 is formed by the outer edge 130 and the outermost circular partition 320. The innermost circular opening 324 is defined by a sidewall 210 of a central induction chamber 200 and the innermost circular partition 320. Other circular openings are formed based on the number of circular partitions 320 in the lower strainer chamber array 300. The circular openings 322, 324 are each divided by multiple radial partitions 310 to preferably form multiple congruent strainer chambers 330 in each concentric opening 322, 324. The chambers 330 do not have to be congruent, and can differ in size without departing from the spirit and scope of the invention.

Alternatively, the lower strainer chamber array 300 may have multiple radial partitions 310 but no circular partitions 320. In such an embodiment, the strainer chambers 330 are defined by the radial partitions 310, outer edge 130 and a portion central to the bottom surface of the pump strainer 10.

Referring to FIG. 2, the bottom edges of each radial partition 310 are shaped so as to form an overall curved interface 80 between the pump strainer 10 and the pool cover 40. This allows the pump strainer 10 to conform naturally to the pool cover 40 without piercing, gouging or otherwise damaging pool cover 40 as a flat surface could. Referring now to FIG. 6 and FIGS. 11-14, the bottom edges of concentric partitions 320 do not contact pool cover 40, thereby providing a clearance 82 through which water 60 may flow from one strainer chamber 330 to the next, and ultimately to the central induction chamber 200. The clearance 82 is formed due to the radial partitions 310 extending past the circular partitions 320. The clearance 82 filters debris 70 and allows the water 60 to flow from one strainer chamber 330 to the next

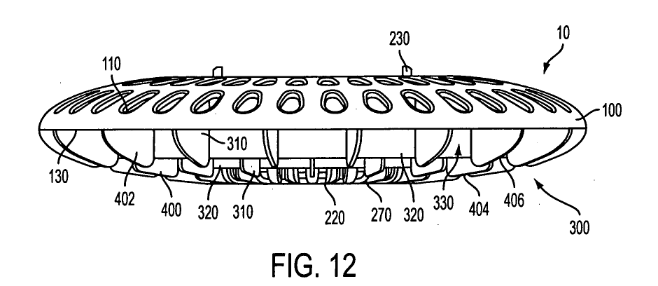

Referring to FIG. 12, the circular partition 320 separates the radial partitions 310 into different tiers 400, 402 that are radially offset from one another. As seen in the embodiment of FIG. 12, the radial partitions 310 in different tiers 400, 402 have bottom surfaces 404, 406 having varying profiles. The bottom surfaces 404 of the radial partitions 310 in the inner tier 400 are generally angled and flat, and the bottom surfaces 406 of the radial partitions 310 in the outer tier 402 are generally curved. Alternatively, the bottom surfaces of all radial partitions 310 may be flat or curved, provided that the desired profile of the bottom surface of the pool strainer 10 is achieved.

Thus, the radial partitions 310 rest on pool cover 40, but circular partitions 320 are formed so as not to extend all the way from upper strainer face 100 to pool cover 40. This allows water to pass from outer strainer chambers 330 toward inner strainer chambers 330 unobstructed by the concentric partitions 320. While clearance 82 allows water 60 to flow unobstructed, debris 70 that is larger than the clearance 82 will be prevented by the circular partitions 320 from reaching the pump 20. The radial partitions 310 can vary in height with respect to the circular partitions 320 to vary the clearance 82 to allow for different straining characteristics. Preferably, the clearance 82 is smaller closer to the induction chamber 200, thereby providing finer straining as the water flows toward central induction chamber 200. Also preferably, radial partitions 310 are circumferentially offset, as shown in FIG. 4, from outermost circular opening 322 toward innermost circular opening 324 to provide a flow of water from one strainer chamber 330 into two separate successive strainer chambers 330. This is shown by arrows 350. This provides improved water flow characteristics and additional straining of the debris 70 from the water 60 to be pumped.

In use, with reference to FIGS. 3 and 4, water flows through lower strainer chamber array 300 from outer strainer chambers 330 toward inner strainer chambers 330, and eventually flows to the sidewall 210 of the induction chamber 200. Water flows into the induction chamber 200 through multiple induction openings 270, which are formed in the sidewall 210 and bottom surface 220 of induction chamber 200, as shown in FIG. 4.

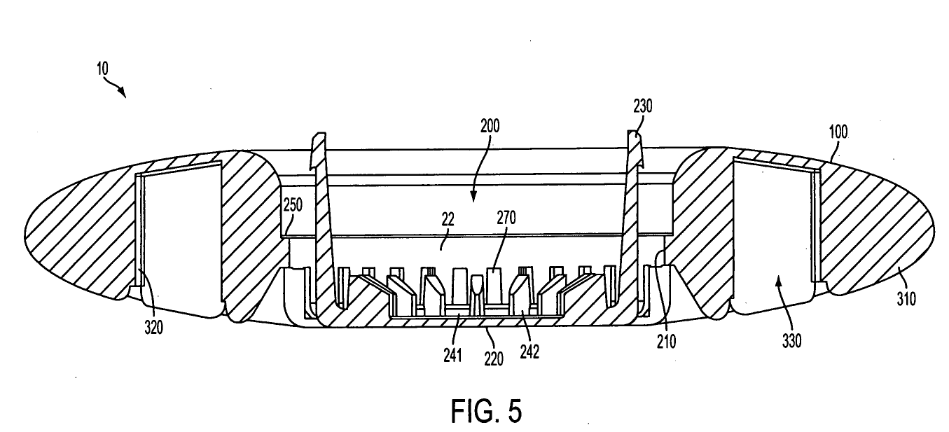

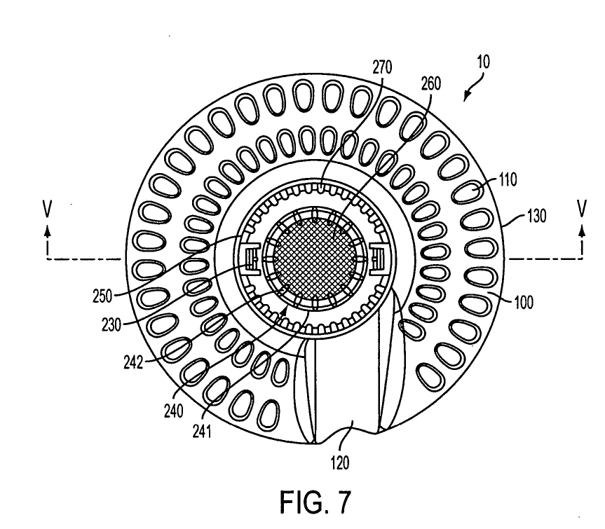

Referring now to FIG. 2, FIG. 3, FIG. 5, and FIG. 7, the induction chamber 200 is configured to position and secure a compatible pump 20. Preferably, the pump 20 is an embodiment of the pumps described in U.S. Pat. Nos. 5,076,763; 5,324,170; and 5,545,012 to William N. Anastos and Stephen B. Boyd. However, it should be clear that other compatible pumps may be utilized with pump strainer 10. The pump 20, positioned in induction chamber 200, is supported by pump seat 250, which can be a molded ledge in the sidewall 210 of the induction chamber 200. A flange or other surface on the pump 20 preferably rests on the pump seat 250, which physicaily supports the pump 20 and creates a top seal to the induction chamber 200. The pump 20 is secured in place by latches 230, which preferably engage a compatible engageable surface on the pump 20 to secure the pump 20 to the pump strainer 10.

As shown in FIG. 6, the pump 20 also preferably includes a pump outlet 23 to which may be connected an outlet hose 30 in order to pump water 60 away from the pool cover 40. Accordingly, a preferred embodiment of the pump strainer 10 of the present invention includes an outlet channel 120 formed primarily in the upper strainer face 100. The outlet channel 120 may also extend into the lower strainer chamber array 300.

Referring back to FIG. 2, FIG. 3, FIG. 5, and FIG. 7, the pump strainer 10 also preferably includes a screen positioner 240 for positioning a screen 260 in induction chamber 200. In a preferred embodiment the screen 260 (shown if FIG. 7) is a metallic or plastic mesh-type screen, however, any suitable screen or filter-type material can be used. The screen 260 is useful to perform the final filtering of the water 60 prior to its entry into the pump 20. The screen 260 is preferably circular and concave, but it should be obvious that many different suitable screens could be designed and used in accordance with the present invention. As shown in FIG. 2, FIG. 3, FIG. 5, and FIG. 7, the screen positioner 240 is substantially circular, and is adjacent to and centered at the bottom of the induction chamber 200. Preferably, the screen positioner 240 includes a screen positioner ring 241 and multiple screen positioner spindles 242. The screen positioner spindles 242 may have angled top surfaces 243 (as best seen in FIG. 3) to allow a concave screen to be cradled within screen positioner 240 in close proximity to pump inlet 22 of the pump 20. The screen 260 provides a final level of filtration, straining small debris 70 from the water 60 before it is pumped away from the cover 40.

The pump strainer 10 is preferably formed as a single piece of molded plastic. The pump strainer 10 may be formed from the acetal copolymer KEPITAL®, described as “a medium viscosity grate for general injection molding” (product number F20-03), and available from the Korea Engineering Plastics Co., Ltd. (Head Office Tel. 82-2-707-6841/48). It should be apparent that other materials and methods may be used to manufacture the pump strainer 10 without departing from the spirit and scope of the present invention.

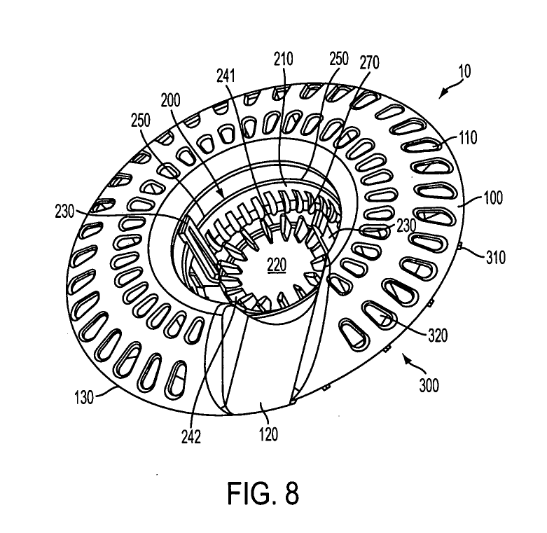

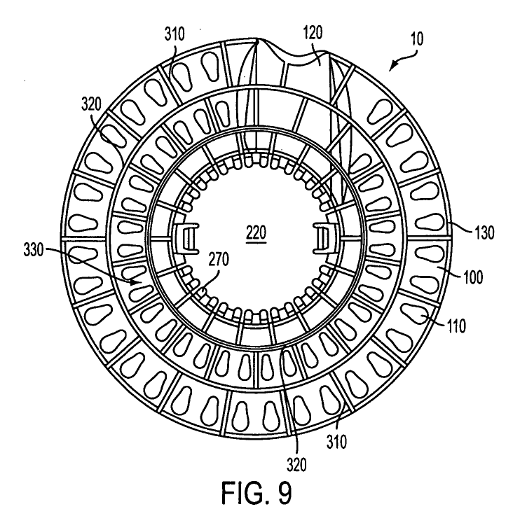

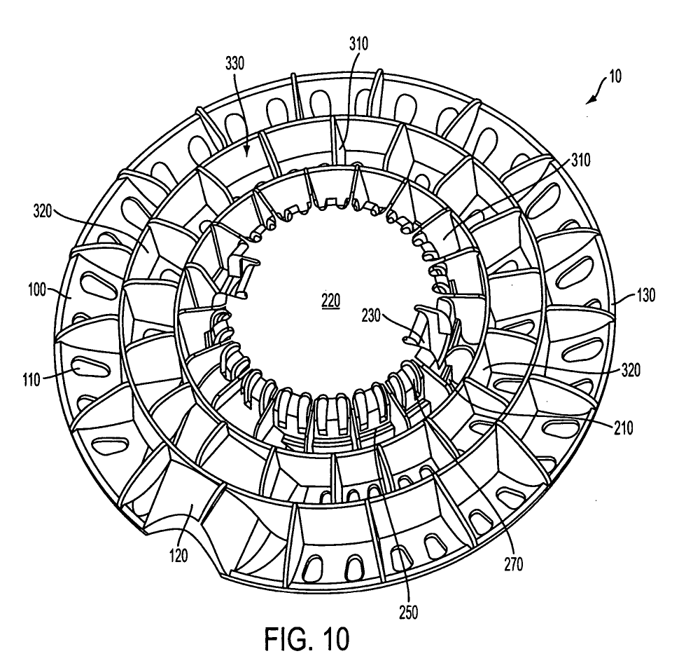

Although not cited explicitly in the description above, FIGS. 8-10 utilize like reference numerals for like components described above and are offered to provide additional views of the pump strainer 10 which may be instructive.

The above description and drawings are only illustrative of preferred embodiments of the present invention, and are not intended to limit the present inventions thereto. Any subject matter or modification thereof which comes within the spirit and scope of the following claims is to be considered part of the present inventions.

What is claimed as new and desired to be protected by Letters Patent of the United States is:

1. A pump strainer for use on a pool cover comprising:
a bottom surface, said bottom surface defining a curved profile over at least a portion of said bottom surface.

2. The pump strainer of claim 1, wherein said curved profile generally conforms to a portion of a pool cover that has accumulated water.

3. The pump strainer of claim 1, wherein said curved profile is at a periphery of said bottom.

4. The pump strainer of claim 1, wherein said bottom surface also defines a substantially flat profile over at least a portion of said bottom.

5. The pump strainer of claim 1, further comprising a pump.

6. The pump strainer of claim 1, wherein said bottom surface comprises a plurality of radial partitions.

7. The pump strainer of claim 6, further comprising at least one circular partition.

8. The pump strainer of claim 7, wherein at least one circular partition includes multiple circular partitions.

9. The pump strainer of claim 8, wherein said multiple circular partitions and said plurality of radial partitions form multiple chambers.

10. The pump strainer of claim 9, wherein said multiple chambers comprise outer chambers and inner chambers circumferentially offset from said outer chambers.

11. The pump strainer of claim 7, wherein said plurality of radial partitions extend past said at least one circular partition to define a clearance.

12. The pump strainer of claim 11, wherein said clearance performs a straining function.

13. The pump strainer of claim 8, wherein said plurality of radial partitions extend past said multiple circular partitions by different distances to define different clearances.

14. The pump strainer of claim 8, wherein said plurality of circular partitions include an outermost circular partition and at least one circular partition radially inward of said outermost partition.

15. The pump strainer of claim 1 further comprising a top surface having a plurality of apertures.

16. The pump strainer of claim 15, wherein said plurality of apertures allow water to flow into a plurality of chambers.

17. The pump strainer of claim 13, wherein said plurality of radial partitions comprise outer radial partitions and inner radial partitions circumferentially offset from said outer radial partitions.

18. The pump strainer of claim 13, further comprising a screen positioner and a screen.

19. A pump strainer for use on a pool cover comprising:
a bottom surface, said bottom surface having a plurality of strainer chambers.

20. The pump strainer of claim 19, wherein said plurality of strainer chambers are defined by a plurality of radial partitions and circular partitions.

21. The pump strainer of claim 20, wherein said plurality of radial partitions extend past said plurality of circular partitions such that when said pump strainer rests on a pool cover, said plurality of radial partitions are in contact with said pool cover.

22. The pump strainer of claim 19, wherein said bottom surface has a generally curved profile.

23. The pump strainer of claim 19, wherein said plurality of radial partitions extend past said plurality of circular partitions to form a clearance.

24. The pump strainer of claim 23, wherein said clearance performs a straining function.

25. The pump strainer of claim 18, further comprising an upper surface having a plurality of apertures.

26. The pump strainer of claim 23, wherein said plurality of circular partitions includes an outer circular partition and an inner circular partition concentric with said outer circular partition.

27. The pump strainer of claim 25, wherein said upper surface has a generally curved profile.

28. The pump strainer of claim 19, wherein said plurality of strainer chambers comprises a plurality of outer chambers and a plurality of inner chambers concentric with said plurality of outer chambers.

29. The pump strainer of claim 28 wherein said plurality of inner chambers are circumferentially offset from said plurality of outer chambers.

30. The pump strainer of claim 20, wherein said plurality of radial partitions comprises a plurality of outer partitions and a plurality of inner partitions concentric with said plurality of outer partitions.

31. The pump strainer of claim 19, further comprising a latch mechanism to accommodate a pump.

32. A pump strainer for use on a pool cover comprising:
a bottom surface, said bottom surface having at least one circular partition.

33. The pump strainer of claim 32, further comprising an upper surface having a plurality of apertures.

34. The pump strainer of claim 33, wherein said apertures are formed in a plurality of sizes.

35. The pump strainer of claim 30, wherein said bottom surface has a generally curved profile.

36. The pump strainer of claim 29, wherein said upper surface has a generally curved profile.

37. The pump strainer of claim 33, wherein said upper surface further comprises an outlet channel for positioning an outlet hose.

38. A pump strainer for use on a pool cover comprising:
a bottom surface having a generally curved profile, said bottom surface having a plurality of radial partitions and a plurality of circular partitions defining a plurality of chambers.

39. The pump strainer of claim 38, further comprising a screen.

40. The pump strainer of claim 38, further comprising a pump.

41. The pump strainer of claim 38, further comprising an upper surface having apertures.

42. The pump strainer of claim 41, wherein said upper surface further comprises an outlet channel.

43. A pump strainer comprising:
a top surface; and
a bottom surface, said bottom surface being substantially open to intake a fluid into the pump strainer.

44. The pump strainer of claim 43, wherein said top surface has a substantially curved profile for shedding debris from said fluid flowing into said pump strainer.

45. The pump strainer of claim 43, wherein said pump strainer bottom surface comprises a plurality of chambers defined by a plurality of radial partitions.

46. The pump strainer of claim 44, wherein said plurality of radial partitions have bottom surfaces that are generally flat.

47. The pump strainer of claim 44, wherein said plurality of radial partitions have bottom surfaces that are generally curved.

48. The pump strainer of claim 44, wherein said plurality of radial partitions have bottom surfaces that are generally angled.

49. The pump strainer of claim 45, further comprising a circular partition separating said plurality of radial partitions into at least two tiers of radial partitions, wherein said at least two tiers of radial partitions are radially offset.

50. The pump strainer of claim 49, wherein said plurality of radial partitions have bottom surfaces.

51. The pump strainer of claim 50, wherein said bottom surfaces of one of said at least two tiers of radial partitions are generally flat, and said bottom surfaces of the other of said at least two tiers of radial partitions are generally curved.

52. The pump strainer of claim 51, wherein bottom surface has a substantially curved profile.
